(19) United States
(12) Patent Application Publication
(10) Pub. No.: US 2020/0200561 A1
(43) Pub. Date: Jun. 25, 2020

(54) DRIVING ASSIST DEVICE, DRIVING ASSIST METHOD, AND DRIVING ASSIST PROGRAM

(71) Applicant: TOYOTA JIDOSHA KABUSHIKI KAISHA, Toyota-shi (JP)

(72) Inventor: Xin JIN, Nagoya-shi (JP)

(73) Assignee: TOYOTA JIDOSHA KABUSHIKI KAISHA, Toyota-shi (JP)

(21) Appl. No.: 16/686,276

(22) Filed: Nov. 18, 2019

(30) Foreign Application Priority Data
Dec. 25, 2018 (JP) 2018-241235

(51) Int. Cl. G01C 21/36; H04W 4/46

(52) U.S. Cl. CPC G01C 21/3629; H04W 4/46; G01C 21/3697

(57) ABSTRACT

A driving assist device includes: an acquisition unit configured to acquire vehicle information regarding peripheral vehicles; an identification unit configured to identify a preceding vehicle traveling ahead of an own vehicle, based on the acquired vehicle information and on location information regarding the own vehicle; and a guidance unit configured to provide, based on the vehicle information regarding the identified preceding vehicle and on route information regarding the own vehicle, a voice guidance of a route for the own vehicle using a visual feature of the preceding vehicle that matches in behavior with the own vehicle.

### INCORPORATION BY REFERENCE

The disclosure of Japanese Patent Application No. 2018-241235 filed on Dec. 25, 2018 including the specification, drawings and abstract is incorporated herein by reference in its entirety.

### BACKGROUND

### 1. Technical Field

The present disclosure relates to a driving assist device, a driving assist method, and a driving assist program.

### 2. Description of Related Art

Disclosed in Japanese Patent Application Publication No. H05-296774 is an in-vehicle navigator that assists a driver to easily recognize a travel direction at an intersection on a guidance route. When a traveling vehicle approaches an intersection, the in-vehicle navigator displays, for example, an arrow indicating a travel direction on a guide screen, while outputting a voice guidance “go straight (or turn left or turn right) at the spot 150 m ahead.”

### SUMMARY

However, the in-vehicle navigator guides a travel route by using a static object, such as intersections, as a landmark. Therefore, in the case of a travel route where, for example, intersections continuously appear at a short interval, it may be difficult for the driver to picture which intersection to travel in which direction. Hence, the driver may take a wrong travel route.

Accordingly, it is an object of the present disclosure to provide a driving assist device, a driving assist method, and a driving assist program, capable of guiding a travel route by using a dynamic object as a landmark.

A driving assist device according to one aspect of the present disclosure includes: an acquisition unit; an identification unit; and a guidance unit. The acquisition unit is configured to acquire vehicle information regarding peripheral vehicles. The identification unit is configured to identify a preceding vehicle traveling ahead of an own vehicle, based on the acquired vehicle information and on location information regarding the own vehicle. The guidance unit is configured to provide, based on the vehicle information regarding the identified preceding vehicle and on route information regarding the own vehicle, a voice guidance of a route for the own vehicle using a visual feature of the preceding vehicle that matches in behavior with the own vehicle.

In the above aspect, the acquisition unit may acquire the vehicle information through vehicle-to-vehicle communication.

In the above aspect, when a route included in the vehicle information matches with a route included in the route information, the guidance unit may provide the voice guidance of the route for the own vehicle using the visual feature of the preceding vehicle.

In the above aspect, the visual feature may include at least one of a vehicle type and a vehicle color.

In the above aspect, the behavior of the own vehicle may be turning at an intersection.

A driving assist method according to another aspect of the present disclosure is a method to be executed by a processor, the method including: an acquisition step; an identification step; and a guidance step. The acquisition step is for acquiring vehicle information regarding peripheral vehicles. The identification step is for identifying a preceding vehicle traveling ahead of an own vehicle, based on the acquired vehicle information and on location information regarding the own vehicle. The guidance step is for providing, based on the vehicle information regarding the identified preceding vehicle and on route information regarding the own vehicle, a voice guidance of a route for the own vehicle using a visual feature of the preceding vehicle that matches in behavior with the own vehicle.

A driving assist program according to another aspect of the present disclosure causes a computer to function as: an acquisition unit; an identification unit; and a guidance unit. The acquisition unit is configured to acquire vehicle information regarding peripheral vehicles. The identification unit is configured to identify a preceding vehicle traveling ahead of an own vehicle, based on the acquired vehicle information and on location information regarding the own vehicle. The guidance unit is configured to provide, based on the vehicle information regarding the identified preceding vehicle and on route information regarding the own vehicle, a voice guidance of a route for the own vehicle using a visual feature of the preceding vehicle that matches in behavior with the own vehicle.

The present disclosure can provide a driving assist device, a driving assist method, and a driving assist program, capable of guiding a travel route by using a dynamic object as a landmark.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 illustrates a schematic configuration of a driving assist system in an embodiment; and

FIG. 2 is a flowchart for describing the procedure of a driving assist process in the embodiment.

### DETAILED DESCRIPTION OF EMBODIMENTS

Hereinafter, preferable embodiments of the present disclosure will be described with reference to the accompanying drawings. In the drawings, identical or like component members are designated by identical or like numerals. The driving assist system according to the embodiment is a system mounted on a vehicle to assist driving of a driver as a user.

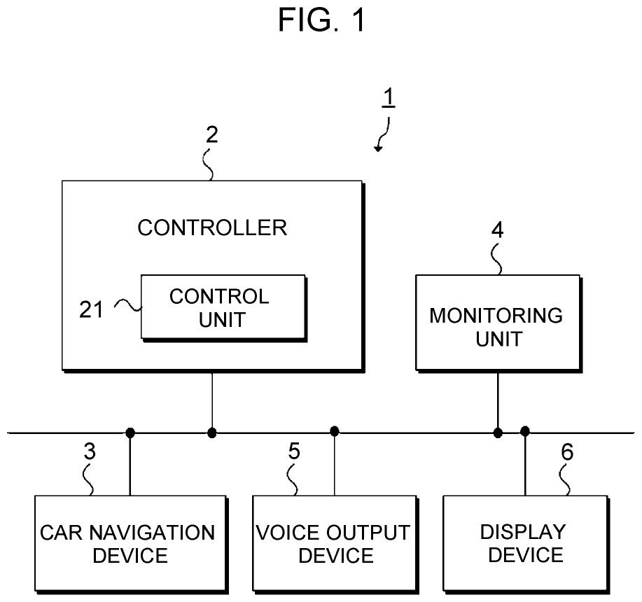

With reference to FIG. 1, the schematic configuration of a driving assist system 1 according to an embodiment will be described. For example, the driving assist system 1 includes a controller (driving assist device) 2, a car navigation device 3, a monitoring unit 4, a voice output device 5, and a display device 6. The component members are each connected through, for example, a communication bus, and configured to be communicable with each other.

The controller 2 is configured by including, for example, a control unit including a central processing unit (CPU) and a memory, an operation unit, and a communication device as physical components. When the CPU executes prescribed programs stored in the memory, later-described driving assist functions, or the like, are implemented.

The car navigation device 3 has a navigation function that guides a travel route from a current location to a destination using voice or the like. A publicly-known navigation function can properly be applied to the navigation function.

The car navigation device 3 is configured by including, for example, a control unit including a CPU and a memory, an operation unit, and a communication device as physical components. When the CPU executes a prescribed program stored in the memory, the navigation function of the car navigation device 3 is implemented.

The monitoring unit 4 is configured with various kinds of devices for monitoring the situation around the vehicle. The various kinds of devices include, for example, a vehicle-to-vehicle communication device and a road-to-vehicle communication device, as well as a sensor device, such as an image sensor, a camera, a millimeter-wave radar, and a light detection and ranging (LIDAR).

The vehicle-to-vehicle communication device is a wireless communication device that performs wireless communication at any time with other vehicles that are present around the own vehicle to exchange vehicle information with each other. The vehicle information includes, for example, vehicle body information, route information, location information, and travel information. The vehicle body information includes, for example, information regarding a vehicle type, a vehicle color, and the like. The route information includes, for example, information regarding a destination, a travel route, and the like. The location information includes information regarding latitude and longitude measured with a global positioning system (GPS), and the like. The travel information includes, for example, information regarding speed, acceleration, deceleration, and the like.

For example, the voice output device 5 is a speaker to output voice, music, and the like. For example, the display device 6 is a display that displays characters, images, moving images, and the like.

For example, the control unit 21 of the controller 2 has driving assist functions in the form of an acquisition unit, an identification unit, a guidance unit, and the like. The driving assist functions will be described below.

The control unit 21 acquires vehicle information regarding peripheral vehicles through, for example, vehicle-to-vehicle communication (acquisition unit).

The control unit 21 identifies a preceding vehicle traveling ahead (immediately ahead) of the own vehicle, based on the acquired vehicle information and on the location information regarding the own vehicle (identification unit).

The control unit 21 provides, based on the vehicle information regarding the identified preceding vehicle and on the route information regarding the own vehicle, a voice guidance of a route for the own vehicle using a visual feature of the preceding vehicle that matches in behavior with the own vehicle (guidance unit). Whether the behavior of the own vehicle matches with the behavior of the preceding vehicle can be determined based on, for example, whether the route included in the route information regarding the own vehicle matches with the route included in the vehicle information regarding the preceding vehicle. Whether the routes match with each other can be determined based on whether, for example, the intersections to turn next match with each other.

The visual feature of the preceding vehicle includes, for example, a vehicle type, a vehicle color, or the like. The control unit 21 illustratively outputs a voice guidance “turn right following the proceeding white CROWN” from the voice output device 5.

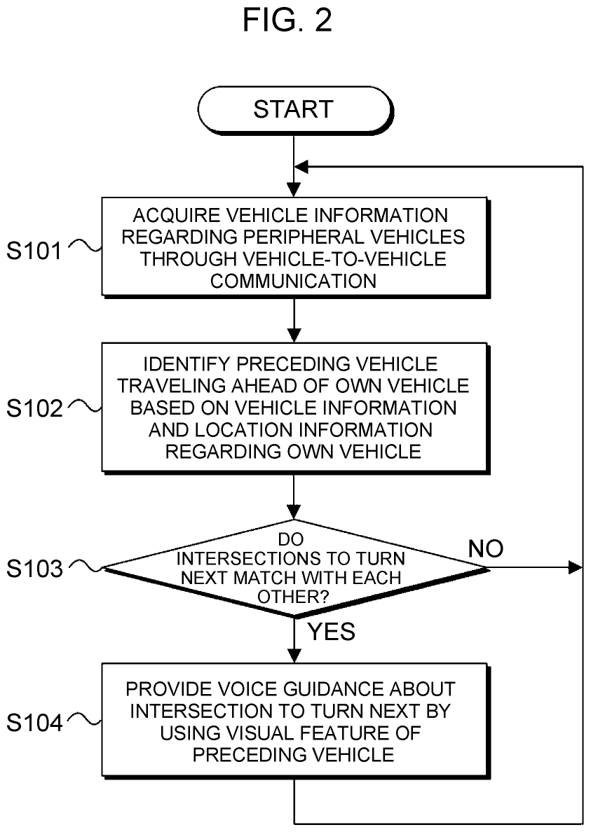

With reference to FIG. 2, an example of the procedure of a driving assist process executed in the controller 2 will be described. The driving assist process is repeatedly executed while the car navigation device 3 guides the travel route from the current location to the destination.

First, the control unit 21 of the controller 2 acquires vehicle information regarding peripheral vehicles through vehicle-to-vehicle communication (step S101).

Next, the control unit 21 identifies a preceding vehicle traveling ahead of the own vehicle based on the vehicle information acquired in step S101 and on the location information regarding the own vehicle (step S102).

Next, the control unit 21 determines whether the intersections to turn next match with each other based on the vehicle information regarding the preceding vehicle identified in step S102, and on the route information regarding the own vehicle (step S103). When the determination result is NO (step S103, NO), the process shifts to step S101.

When the control unit 21 determines in step S103 that the intersections to turn next match with each other (step 103; YES), the control unit 21 provides a voice guidance about the intersection to turn next by using a visual feature of the preceding vehicle, such as “turn right following the preceding white CROWN” (step S104). The process then shifts to step S101.

As described in the foregoing, the driving assist system 1 in the embodiment can identify a preceding vehicle based on the vehicle information regarding peripheral vehicles and on the location information regarding the own vehicle, and provide, based on the vehicle information regarding the identified preceding vehicle and on route information regarding the own vehicle, a voice guidance of the route for the own vehicle using a visual feature of the preceding vehicle that matches with the own vehicle with respect to the intersection to turn next.

Therefore, since the driving assist system 1 in the embodiment can guide the travel route by using a dynamic preceding vehicle as a landmark, the driving assist system 1 enables the driver to easily recognize the travel route. This makes it possible to reduce the possibility of taking a wrong travel route.

The present disclosure is not limited to the embodiment disclosed, but may be performed in other various forms without departing from the scope of the present disclosure. Therefore, the embodiment disclosed is in all respects illustrative and is not considered as the basis for restrictive interpretation. For example, the order of the process steps described above may optionally be changed, or the process steps may be executed in parallel, without producing inconsistency in the contents of the process.

What is claimed is:

1. A driving assist device, comprising:
an acquisition unit; an identification unit; and a guidance unit,
the acquisition unit being configured to acquire vehicle information regarding peripheral vehicles;
the identification unit being configured to identify a preceding vehicle traveling ahead of an own vehicle, based on the acquired vehicle information and on location information regarding the own vehicle; and
the guidance unit being configured to provide, based on the vehicle information regarding the identified preceding vehicle and on route information regarding the own vehicle, a voice guidance of a route for the own vehicle using a visual feature of the preceding vehicle that matches in behavior with the own vehicle.

2. The driving assist device according to claim 1, wherein the acquisition unit acquires the vehicle information through vehicle-to-vehicle communication.

3. The driving assist device according to claim 1, wherein when a route included in the vehicle information matches with a route included in the route information, the guidance unit provides the voice guidance of the route for the own vehicle using the visual feature of the preceding vehicle.

4. The driving assist device according to claim 1, wherein the visual feature includes at least one of a vehicle type and a vehicle color.

5. The driving assist device according to claim 1, wherein the behavior of the own vehicle is turning at an intersection.

6. A driving assist method to be executed by a processor, the method comprising:
an acquisition step; an identification step; and a guidance step,
the acquisition step being for acquiring vehicle information regarding peripheral vehicles;
the identification step being for identifying a preceding vehicle traveling ahead of an own vehicle, based on the acquired vehicle information and on location information regarding the own vehicle; and
the guidance step being for providing, based on the vehicle information regarding the identified preceding vehicle and on route information regarding the own vehicle, a voice guidance of a route for the own vehicle using a visual feature of the preceding vehicle that matches in behavior with the own vehicle.

7. A driving assist program for causing a computer to function as:
an acquisition unit; an identification unit; and a guidance unit,
the acquisition unit being configured to acquire vehicle information regarding peripheral vehicles;
the identification unit being configured to identify a preceding vehicle traveling ahead of an own vehicle, based on the acquired vehicle information and on location information regarding the own vehicle; and
the guidance unit being configured to provide, based on the vehicle information regarding the identified preceding vehicle and on route information regarding the own vehicle, a voice guidance of a route for the own vehicle using a visual feature of the preceding vehicle that matches in behavior with the own vehicle.
